(19) United States
(12) Patent Application Publication
(10) Pub. No.: US 2010/0316039 A1
(43) Pub. Date: Dec. 16, 2010

(54) APPARATUS AND METHOD FOR GENERATING RANGING CODE

(75) Inventors: Yoon Ju LEE, Daejeon (KR); Sung Hoon Kim, Daejeon (KR); Jihyung Kim, Daejeon (KR); Beom-Su Seo, Daejeon (KR); Kyeong Ho Lee, Daejeon (KR); Joong Bae Kim, Daejeon (KR); Myung Chan Roh, Daejeon (KR); Choul Soo Jang, Daejeon (KR); Seung-Woog Jung, Daejeon (KR); Seung-Ik Lee, Daejeon (KR); Joong-Ki Park, Daejeon (KR); Chul-Hee Han, Yongin-si (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon (KR); SAMSUNG THALES CO., LTD., Gyeongsanbuk-do (KR)

(21) Appl. No.: 12/793,832

(22) Filed: Jun. 4, 2010

(30) Foreign Application Priority Data
Jun. 16, 2009 (KR) 10-2009-0053581

(51) Int. Cl. H04B 7/216; H04L 27/28

(52) U.S. Cl. 370/342; 375/260

(57) ABSTRACT

An apparatus for generating a ranging code extracts a ranging code in each ranging mode, using a ranging code table storing one period data in bytes of the PN code according to a reference UL PermBase number, and an offset table that stores byte offsets for the start positions of the PN codes of the reference UL PermBase number and the other plurality of UL PermBase numbers and bit offsets in the byte including the start positions, on the basis of the PN code according to the reference UL PermBase number.

### CROSS-REFERENCE TO RELATED APPLICATION

This application claims priority to and the benefit of Korean Patent Application No. 10-2009-0053581 filed in the Korean Intellectual Property Office on Jun. 16, 2009, the entire contents of which are incorporated herein by reference.

### BACKGROUND OF THE INVENTION

(a) Field of the Invention

The present invention relates to an apparatus and a method for generating a ranging code.

(b) Description of the Related Art

Four ranging modes are defined in an IEEE 802.16e OFDMA (orthogonal frequency division multiple access) physical layer. The four ranging modes include initial ranging, periodic ranging, handover ranging, and bandwidth request ranging.

The number of available ranging codes in each ranging mode is set by the base-station and broadcasted using the UCD (uplink channel descriptor) message which is transmitted periodically and updated whenever the system configurations that are described in that message are changed, and the length of the ranging code is 144 bits and the number of available codes is 256, numbered 0 to 255. Each base station uses a partial group of the available codes, and the start code number of the partial group is defined by ‘S’ (0≦S≦255). The ‘S’ implies the offset of the ranging code.

In general, a PN (pseudo noise) code, which is acquired by a generation polynomial 1+X¹+X⁴+X⁷+X¹⁵ in a PRBS (pseudo random binary sequence) generator composed of a register and adders, is used as the ranging code.

N 144-bit codes that are generated by equivalently dividing a long series, which is generated by clocking the PRBS generator from 144×(S mod 256) times to 144×((S+N) mod 256)−1 times, are used for the initial ranging.

M 144-bit codes that are generated by equivalently dividing a long series, which is generated by clocking the PRBS generator from 144×((S+N) mod 256) times to (144×((S+N+M) mod 256))−1 times, are used for the handover ranging.

Further. L 144-bit codes that are generated by equivalently dividing a long series, which is generated by clocking the PRBS generator from 144×((S+N+M) mod 256) times to (144×((S+N+M+L) mod 256))−1 times, are used for the periodic ranging.

Finally, O 144-bit codes that are generated by equivalently dividing a long series, which is generated by clocking the PRBS generator from 144×((S+N+M+L) mod 256) times to (144×((S+N+M+L+O) mod 256))−1 times, are used for the bandwidth request ranging.

A large amount of unnecessary calculation should be performed to initialize the register to a desired state when the value of ‘S’ is large even though the value of (N+M+L+O) is small, and then it takes a long time to generate the ranging code.

In worst case (S=255), the PRBS generator should operate as many as 36,720 (=255×144) clock times prior to acquire desired ranging codes. This additional calculation amounts to 459 microseconds for the hardware logic (e.g. FPGA) operating in 80 MHz system clock.

In DSP (Digital Signal Processor) implementation, latency caused by large S also exists. In FPGA implementation, PRBS generator can be designed using very little logic slices, and though latency is unavoidable in the PRBS generator, other blocks can be operated simultaneously. But in single-core DSP, latency produced by the PRBS generator means blocking of the CPU processing by the PRBS generator while additional calculation is performing. So, the effect of additional calculation caused by large S is more critical in the DSP implementation than in the hardware logic (e.g. FPGA) implementation.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for generating a ranging code having advantages of generating a ranging code according to each ranging mode with a small amount of calculation. An exemplary embodiment of the present invention provides an apparatus for generating a ranging code, using a PN (pseudo noise) code. The apparatus for generating a ranging code includes a ranging code table, an offset table, and a ranging code extractor. The ranging code table stores one period data of a PN code according to a reference uplink permutation base(UL PermBase) number of a plurality of UL PermBase numbers given to each uplink permutation zone, in bytes. The offset table stores byte offsets representing a byte index that includes the first PN code for corresponding UL PermBase number and bit offsets representing a bit position of the PN code in that byte of codes. Further, the ranging code extractor extracts byte offsets and bit offsets corresponding to the UL PermBase number of a corresponding frame in the offset table, and extracts the start position of a ranging code, using the byte offsets and the bit offsets extracted from the ranging code table.

Another embodiment of the present invention provides a method of generating a ranging code, using a PN (pseudo noise) code. The method of generating a ranging code includes: receiving a uplink permutation base(UL PermBase) number of a corresponding frame; extracting a byte offset and a bit offset about the start position of PN codes in the ranging code table for other UL PermBase numbers in a plurality of UL PermBase numbers given to each uplink permutation zone from an offset table that stores byte offsets representiong a byte index than includes the first PN code for corresponding UL PermBase number and bit offsets representing a bit position of the PN code in that byte of codes; extracting the start position of a ranging code, using the byte offset and the bit offset extracted from the ranging code table storing one period data in bytes of the PN code corresponding to the reference UL PermBase number; and extracting the ranging code from each ranging mode from the start position of the ranging code in the ranging code table.

According to an exemplary embodiment of the present invention, it is possible to generate a ranging code according to each mode, with a small amount of calculation. In particular, it is not necessary to perform calculations that are performed to initialize the register to a desired condition in a PRBS generator. Thus, the processing time of calculating ranging codes depends on the value of (N+M+L+O) but not on the value of ‘S’, and the amount of reduction in processing time is considerable especially when the value of ‘S’ is large.

### BRIEF DESCRIPTION OF THE DRAWINGS

FIG. 1 is a diagram schematically illustrating an apparatus for generating a ranging code according to an exemplary embodiment of the present invention,

FIG. 2 is a diagram showing an exemplary embodiment of byte offsets and bit offsets stored in an offset table, and

FIG. 3 is a flowchart illustrating a method for generating a ranging code according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification and claims, unless explicitly described to the contrary, the word “comprise” and variations such as “comprises” or “comprising” will be understood to imply the inclusion of stated elements but not the exclusion of any other elements.

Hereinafter, an apparatus and a method for generating a ranging code according to an exemplary embodiment of the present invention are described in detail with reference to the accompanying drawings.

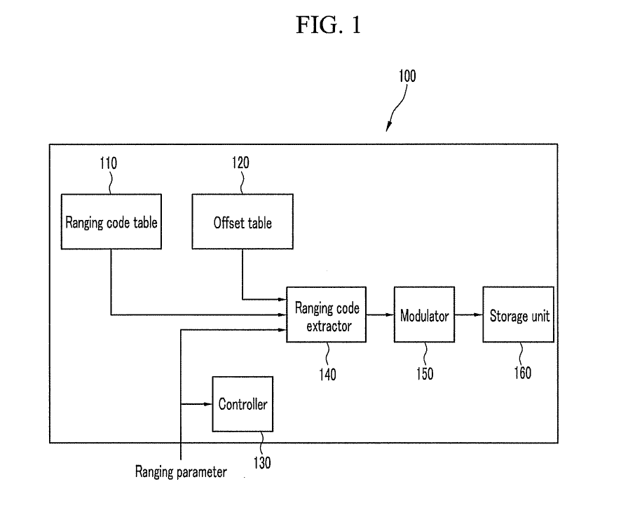

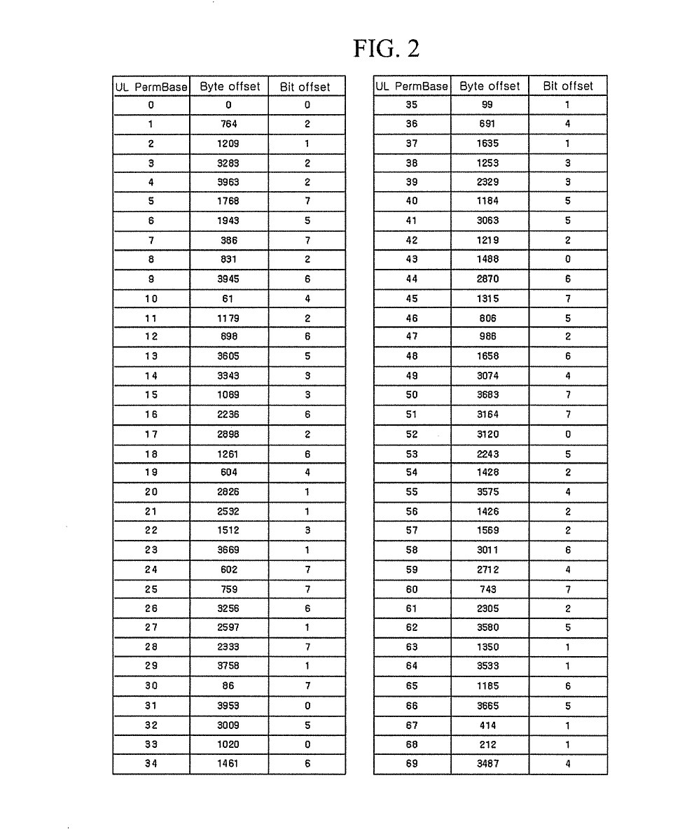

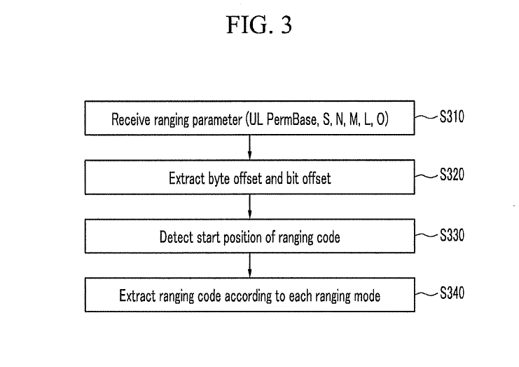

FIG. 1 is a diagram schematically illustrating an apparatus for generating a ranging code according to an exemplary embodiment of the present invention, and FIG. 2 is a diagram showing an exemplary embodiment of byte offsets and bit offsets stored in an offset table. FIG. 3 is a flowchart illustrating a method for generating a ranging code according to an exemplary embodiment of the present invention.

Referring to FIG. 1, a ranging code generator 100 includes a ranging code table 110, an offset table 120, a controller 130, a ranging code extractor 140, a modulator 150, and a storage unit 160.

The ranging code table 110 stores one period data of a PN code according to a reference uplink permulation base(referred to as “UL PurmBase” hereinafter) number (e.g., UL PurmBase number is 0) in bytes. For example, when the one period data of the PN code is 32,767 bits, 4096 bytes can be stored in the ranging code table 110.

The PN code is generated in the PRBS generator (not shown). A shift register (not shown) of the PRBS generator (not shown) is initialized by the UL PermBase number of “00101011”, and 7 bits and the PN code are generated by a generation polynomial 1+X¹+X⁴+X⁷+X¹⁵.

The UL PermBase changes permutation in accordance with a cell identification number (Cell ID), such that a value showing the cell identification number is defined in 7 bits, given by a management entity, and is included in an uplink channel descriptor (UCD).

The UL PermBase number is given for each uplink permutation zone and is used for tile permutation when an uplink subcarrier is allocated, and is also used as an initial value of the PRBS generator (not shown) for generating a ranging code. Further, even in cells using the same frequency assignment (FA), the physical subcarrier groups with the same logic subchannels become different in accordance with the UL PermBase number, and the 144-bit values become different even in the same ranging codes.

The PN code is a periodic code, such that the PN code initialized with the reference UL PermBase number has the same value, except for the start position, as a PN code initialized with a UL PermBase number that is different from the reference UL PermBase number. Accordingly, the ranging code generator 100 according to an exemplary embodiment of the present invention stores one period data of the PN code according to the reference UL PermBase number in bytes in the ranging code table 110, and then extracts a ranging code corresponding to a specific UL PermBase number from the ranging code table 110.

The offset table 120 stores information about the start position of PN codes in the ranging code table for other UL PermBase numbers. The offset table 120 consists of byte offsets and bit offsets. The byte offset tells us the byte index that includes the first PN code for corresponding UL PermBase number. The bit offset tells us the bit position of the PN code in that byte of codes.

The byte offsets and the bit offsets can be acquired by comparing the conditions of the shift register (not shown) for every clock signals in the PRBS generator (not shown), and the acquired byte offsets and bit offsets may be stored in the offset table 120, as shown in FIG. 2.

The controller 130 receives UL PermBase numbers, and S, N, M, L, and O values that are ranging parameters needed for generating a ranging code, for each frame. 256 ranging codes numbered 0 to 255 are used, and each base state uses a partial group of available codes. The partial group is defined by the letter ‘S’ (0≦S≦255), and the ‘S’ is the offset of a ranging code. Further, the values N, M, L, and O are values of ranging codes used for the initial ranging, handover ranging, periodic ranging, and bandwidth request ranging, respectively.

When receiving the ranging parameter of the present frame, the controller 130 compares the ranging parameter of the present frame with the ranging parameter of the previous frame and determines whether to extract the ranging code. When the ranging parameter of the present frame is the same as the ranging parameter of the previous frame, the ranging code extracted from the previous frame can be used, such that it is not necessary to extract a ranging code again. Therefore, the controller 130 does not activate the ranging code extractor 140 and the modulator 150. On the other hand, when the ranging parameter of the present frame is different from the ranging parameter of the previous frame, the controller 130 determines to extract a ranging code and activates the ranging code extractor 140 and the modulator 150.

Referring to FIG. 1 and FIG. 3, the ranging code extractor 140 receives the UL PermBase numbers, and S, N, M, L, and O values, which are ranging parameters, for each frame (S310), and extracts byte offsets and bit offsets corresponding to the UL PermBase numbers received by the offset table 120 (S320).

The ranging code extractor 140 detects the start positions of ranging codes from the ranging code table 110, using the extracted byte offsets and bit offsets (S330), and extracts ranging codes according to the ranging modes in accordance with the ranging parameters N, M, L, and O values (S340).

The modulator 150 modulates the extracted ranging codes according to the ranging modes. The modulation may be the BPSK (binary phase shift keying), or some other modulation may be used.

The storage unit 160 stores the modulated ranging codes according to the ranging modes.

When the ranging code generator 100 according to an exemplary embodiment of the present invention is typical DSP (digital signal processing), the ranging codes can be extracted by a small amount of calculation. In particular, when ‘S’ is larger than (N+M+L+O), it is necessary for the PRBS generator (not shown) to operate as much as the S×144 clock numbers, but this operation is not needed in the exemplary embodiment of the present invention.

Table 1 shows clock numbers of a method of generating ranging codes with the PRBS generator (not shown) and a method of generating ranging codes by the ranging code generator 100 according to an exemplary embodiment of the present invention.

Table 1 shows the compared result when the compiler optimization option is maximized for the C source that is not optimized in source levels in a specific DSP.

TABLE 1

| | | Method |
|---|---|---|
| | Method of | according to the |
| | related art | present invention |
| UL PermBase number = 5, S = 0, | 17,429 | 13,555 |
| N = M = L = O = 4 | | |
| UL PermBase number = 5, S = 10, | 28,951 | 13,555 |
| N = M = L = O = 4 | | |
| UL PermBase number = 5, S = 50, | 75,301 | 13,555 |
| N = M = L = O = 4 | | |
| UL PermBase number = 5, S = 239, | 292,758 | 13,555 |
| N = M = L = O = 4 | | |

In Table 1, a method of generating a ranging code according to an exemplary embodiment of the present invention can acquire desired ranging codes with a smaller number of clock signals than the methods according to the related art, in which it can be seen that the larger the value ‘S’, the more the difference of the number of clock signals increases.

The above-mentioned exemplary embodiments of the present invention are not embodied by only a apparatus and/or method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for generating a ranging code using a PN (pseudo noise) code, comprising:
a ranging code table that stores one period data of a PN code according to a reference uplink permutation base(UL PermBase) number of a plurality of UL PermBase numbers given to each uplink permutation zone, in bytes;
an offset table that stores byte offsets representing a byte index that includes the first PN code for corresponding UL PermBase number and bit offsets representing a bit position of the PN code in that byte of codes; and
a ranging code extractor that extracts byte offsets and bit offsets corresponding to the UL PermBase number of a corresponding frame in the offset table, and extracts the start position of a ranging code, using the byte offsets and the bit offsets extracted from the ranging code table.

2. The apparatus for generating a ranging code of claim 1, wherein the ranging code extractor receives the UL PermBase number of the corresponding frame and ranging parameters showing the number of generated ranging codes of each ranging mode, and extracts a ranging code for each ranging mode, using the ranging parameters, from the start position of the initial ranging code in the ranging code table.

3. The apparatus for generating a ranging code of claim 2, further comprising
a controller that determines whether to extract a ranging code by comparing the UL PermBase number and the ranging parameter of the corresponding frame with the UL PermBase number and the ranging parameter of a previous frame, and controls the operation of the ranging code extractor in accordance with whether the ranging code is extracted.

4. The apparatus for generating a ranging code of claim 3, wherein the controller does not activate the ranging code extractor when the UL PermBase number and the ranging parameter of the corresponding frame are the same as the UL PermBase number and the ranging parameter of the previous frame.

5. The apparatus for generating a ranging code of claim 1, further comprising:
a modulator that modulates the ranging code for each ranging mode; and
a storage unit that stores the modulated ranging code for each ranging mode.

6. The apparatus for generating a ranging code of claim 1, wherein
the PN code of the reference UL PermBase number and the PN code according to the other UL PermBase number have the same value, and
the PN code of the reference UL PermBase number and the PN code according to the other UL PermBase number are different in the value of the start position.

7. The apparatus for generating a ranging code of claim 2, wherein
the PN code of the reference UL PermBase number and the PN code according to the other UL PermBase number have the same value, and
the PN code of the reference UL PermBase number and the PN code according to the other UL PermBase number are different in the value of the start position.

8. A method of generating a ranging code using PN (pseudo noise) code, comprising:
receiving a uplink permutation base (UL PermBase) number of a corresponding frame;
extracting a byte offset and a bit offset about the start position of PN codes in the ranging code table for other UL PermBase numbers in a plurality of UL PermBase numbers given to each uplink permutation zone from an offset table that stores byte offsets representing a byte index than includes the first PN code for corresponding UL PermBase number and bit offsets representing a bit position of the PN code in that byte of codes;
extracting the start position of a ranging code, using the byte offset and the bit offset extracted from the ranging code table storing one period data in bytes of the PN code corresponding to the reference UL PermBase number; and
extracting the ranging code from each ranging mode from the start position of the ranging code in the ranging code table.

9. The method of generating a ranging code of claim 8, further comprising
receiving a ranging parameter showing the number of ranging codes in each ranging mode, when receiving the UL PermBase,
wherein the ranging codes corresponding to the number of ranging parameters are extracted in each ranging mode.
